(19) United States
(12) Patent Application Publication
(10) Pub. No.: US 2026/0355550 A1
(43) Pub. Date: Nov. 12, 2026

(54) FAN SYSTEM AND METHOD FOR DETERMINING TYPE OF MASK

(71) Applicant: KONINKLIJKE PHILIPS N.V., EINDHOVEN (NL)

(72) Inventors: Jun GU, SHANGHAI (CN); Tao KONG, SHENZHEN (CN); Xuan ZHANG, SHANGHAI (CN); Wei GU, SHANGHAI (CN); Guanqun ZHANG, SHANGHAI (CN); Weizhong CHEN, SHANGHAI (CN)

(21) Appl. No.: 19/140,119

(22) PCT Filed: Dec. 19, 2023
(86) PCT No.: PCT/EP2023/086517

§ 371 Date: Jun. 17, 2025

(30) Foreign Application Priority Data
Dec. 22, 2022 (WO) PCT/CN2022/141201
Mar. 8, 2023 (EP) 23160802.7

(51) Int. Cl. A62B 18/00; A62B 23/02; F04D 27/00

(52) U.S. Cl. CPC A62B 18/006; A62B 23/025; F04D 27/001

(57) ABSTRACT

Embodiments of the present disclosure relate to a fan system. The fan system is adapted to be coupled to a mask, and comprises a fan configured to facilitate an airflow passing through a filter material of the mask and a controller configured to control the fan to operate with a drive signal. The controller is further configured to obtain operation data of the fan driven by a testing drive signal, and determine a type of the mask based on the operation data. In this case, the type is associated with a filtration characteristic of the mask. In accordance with embodiments of the present disclosure, a type of a mask can be automatically identified by the controller based on the operation data of the fan obtained from the fan without additional components, thereby providing a cost saving and design friendly solution.

### FIELD OF THE INVENTION

Embodiments of the present disclosure generally relate to a field of face masks, and more specifically, to a fan system adapted to be coupled to a mask, a face mask, a face mask assembly and a method for determining a type of a mask and a computer program product.

### BACKGROUND OF THE INVENTION

As the environment is becoming more and more complex, face masks become more and more essential in our everyday life. For different environments, people may need to use different type of masks. For example, KN95/N95 masks are needed for highly polluted environment while normal medical face masks with bacterial filtration efficiency (BFE) greater than 95% could be used in a normal environment. Typically, when the face mask is being worn, the temperature and relative humidity inside the face mask increases, which makes the wearer very uncomfortable when he or she breathes. In order to improve comfortableness and effectiveness, a fan can be attached to the mask and facilitate the airflow passing through the face mask.

Since the filtration characteristics of the KN95/N95 masks and the normal medical face masks are different, it is desirable to adapt the performance of the fan to different types of the mask to provide further comfortableness.

### SUMMARY OF THE INVENTION

In view of the foregoing problems, example embodiments of the present disclosure propose solutions for identifying a type of a mask.

In a first aspect of the present disclosure, example embodiments of the present disclosure provide a fan system adapted to be coupled to a mask. The fan system comprises: a fan configured to facilitate an airflow passing through a filter material of the mask; and a controller configured to control the fan to operate with a drive signal. The controller is further configured to: obtain operation data of the fan driven by a testing drive signal; and determine a type of the mask based on the operation data, wherein the type is associated with a filtration characteristic of the mask.

According to the present discourse, the controller is configured to determine the type of the mask solely based on the operation data of the fan. In other words, the controller only receives the operation data of the fan as external inouts, no inputs from, such as, from other sensors.

In some embodiments, the face masks of different types have different filtration characteristics which in turn are associated with the operation performance of the fan. For example, when the fan is driven by a same drive signal to operate under a certain voltage, the fan attached to a face mask with higher filtration characteristics will rotate at a higher speed. Comparatively, the fan attached to a face mask with a lower filtration characteristic will rotate at a lower speed. In this way, the controller can automatically identify a type of a mask based on the operation data of the fan obtained from the fan without additional components, thereby providing a cost saving and design friendly solution.

In some embodiments, the controller may be further configured to determine the type of the mask by: obtaining reference data associated with the testing drive signal, the reference data including operation data of the fan without being coupled to a mask; and determining the type based on the reference data, the operation data, and a preset criterion. The operation performance of the fan may differ from each other even with a same model. With these embodiments, by taking the reference data during an individual operation without being coupled to any mask into consideration, the accuracy of determining the type of the mask can be increased.

In some embodiments, the method may further comprise: a memory, configured to store the reference data and the preset criterion as fan specification. With these embodiments, by providing a memory, the useful data obtained beforehand can be stored.

In some embodiments, the controller may be further configured to determine the type of the mask by: selecting, from the preset criterion, at least one threshold range associated with the testing drive signal; determining a difference between the reference data and the operation data; and in response to determining that the difference is in a first threshold range of the at least one threshold range, determining the type of the mask as a first type, and/or in response to determining that the difference is in a second threshold range of the at least one threshold range, determining the type of the mask as a second type, the second type having a lower filtration characteristics than the first type, and threshold values in the second threshold range is lower than threshold values in the first threshold range. With these embodiments, by comparing a difference between the reference data and the operation data with different threshold ranges associated with different operation settings of the fan, the type of the mask can be determined. In these embodiments, the threshold ranges are directly proportional to the filtration characteristics. For example, a threshold range with higher values may indicate a type of mask with higher filtration characteristics. The filtration characteristics would be indicated by a filtration resistance value for the mask, filtration resistance-pressure difference curve, filtration resistance-flow rate curve, filtration resistance-rotation rate curve tendency, characteristic of the curve, or filtration resistance values of more than one testing points to determine the type of the mask similarly to value comparison.

In some embodiments, determining the difference between the reference data and the operation data may comprise: determining whether an overall airflow passing through the fan system includes breathing airflow based on the operation data; in response to determining that the overall airflow includes the breathing airflow, determining a base value of the operation data and determining the difference between the reference data and the base value, and/or in response to determining that the overall airflow does not include the breathing airflow, determining the difference between the reference data and a value of the operation data. With these embodiments, if the face mask is not being worn at the time that the fan is turned on, the airflow passing through the fan system does not involve a breathing airflow exhaled by the user. In this case, the operation data of the fan is stable. Therefore, any value of the operation data can be used to determine the difference. Correspondingly, if the face mask is being worn at the time that the fan is turned on, the airflow passing through the fan system must include a breathing airflow from the user. The breathing airflow is cyclic which makes the operation data of the has a oscillatory pattern. A base value of the operation data may be selected for determining the difference. In some embodiments, the base may be a maximum value, a minimum value or a mean value of the operation data.

In some embodiments, the controller may be further configured to determine the type of the mask by: obtaining reference data associated with the testing drive signal, the reference data including rated operation data of the fan; and in response to determining that the reference data and the operation data do not satisfy a preset criterion, determining the type of the mask as an abnormal type. With these embodiments, if the mask has an abnormal type, the fan system may not be configured to be adapted to the mask. The fan system the fan system may then stop operating thereby avoiding fail to provide a less comfortable wearing experience.

In some embodiments, the controller may be further configured to: obtain a customized drive signal for the determined type; and control the fan to operate with the customized drive signal. With these embodiments, each type of mask is associated with a suitable customized drive signal for controlling the fan. When the type of the mask is determined, the corresponding customized drive signal can be transmitted to control the fan thereby causing the fan to operate in an optimal state.

In some embodiments, the operation data may comprise at least one of: a speed value and/or sequence of the fan; a current value and/or sequence of the fan; or power consumption value and/or sequence of the fan. With these embodiments, the speed, current value and the power consumption of the fan are all associated with the filtration characteristics of the mask. In this way, the type of the mask can be determined based on any one of the speed, current value and the power consumption.

In a second aspect, example embodiments of the present disclosure provide a mask for covering at least a portion of a face of a wearer to form a mask volume. The mask comprises: a connector for connecting to the wearer; and an integrated filtration sheet arranged between the mask volume and an atmosphere, at least one piece of the integrated filtration sheet is directly and/or indirectly secured to the connector and the integrated filtration sheet having an inlet filtration portion and an outlet filtration portion, wherein the inlet filtration portion and/or the outlet filtration portion has a predetermined filtration characteristic to indicate a type of the mask, one of the inlet filtration portion or the outlet filtration portion is adapted for coupling, the filtration resistance of the one of the inlet filtration portion or the outlet filtration portion is larger than another one of the inlet filtration portion or the outlet filtration portion. According to the disclosure, the filtration characteristic of the mask affects the operation performance of the fan. In other words, the material of the mask is configured to allow a fan system to identify its type with a mechanism in accordance with the present disclose.

In some embodiments, further comprises, a visual indicator to indicate the one of the inlet filtration portion and/or the outlet filtration portion for coupling. With these embodiments, by providing the visual indicator, the inlet filtration portion and the outlet filtration portion for coupling can be clearly distinguished.

In some embodiments, the inlet filtration portion is configured to be passed through by airflow from the atmosphere to the mask volume when the wearer inhales, and the outlet filtration portion is configured to be passed through by airflow from the mask volume to the fan system when the wearer exhales.

In some embodiments, one of the inlet filtration portion or the outlet filtration portion is adapted to connect to the fan system, the filtration resistance of the one of the inlet filtration portion or the outlet filtration portion is larger than another one of the inlet filtration portion or the outlet filtration portion, preferably, the filtration resistance of the one of the inlet filtration portion or the outlet filtration portion is 6 times of another one of the inlet filtration portion or the outlet filtration portion.

In a third aspect, example embodiments of the present disclosure provide a face mask assembly. The face mask assembly comprises: a mask according to the second aspect of the present disclosure; and a fan system according to the first aspect of the present disclosure. The fan system is coupled to the mask and configured to facilitate an airflow passing through the filter material of the mask.

In a fourth aspect, example embodiments of the present disclosure provide a method for determining a type of a mask. The method comprises obtaining operation data of a fan coupled to a mask driven by a testing drive signal. In this case, the fan is configured to facilitate an airflow passing through a filter material of the mask. The method further comprises determining a type of the mask based on the operation data. In this case, the type is associated with a filtration characteristic of the mask.

In a fifth aspect, example embodiments of the present disclosure provide a computer program product. The computer program product comprises a computer readable medium, and the computer readable medium have computer readable code embodied therein. The computer readable code is configured such that, on execution by a controller of a fan system, the controller is caused to perform the method according to the third aspect of the present disclosure.

These and other aspects of the invention will be apparent from and elucidated with reference to the embodiments described hereinafter.

### BRIEF DESCRIPTION OF THE DRAWINGS

Through the following detailed descriptions with reference to the accompanying drawings, the above and other objectives, features and advantages of the example embodiments disclosed herein will become more comprehensible. In the drawings, several example embodiments disclosed herein will be illustrated in an exemplary and in a non-limiting manner, wherein:

FIGS. 1A-1B schematically illustrate a face mask assembly in accordance with embodiments of the present disclosure;

FIG. 2 schematically illustrates a fan system in accordance with embodiments of the present disclosure;

FIG. 3 schematically illustrates a mask in accordance with embodiments of the present disclosure;

FIG. 4 schematically illustrates a diagram of operation data of the fan over different filtration resistance in accordance with embodiments of the present disclosure;

FIGS. 5A-5C schematically illustrate schematic diagrams of airflows passing through the face mask assembly in accordance with embodiments of the present disclosure;

FIG. 6 schematically illustrates a flowchart of a method for determining a type of a mask in accordance with embodiments of the present disclosure;

FIG. 7 schematically illustrates a flowchart of a method for determining a type of a mask based on the collected data in accordance with embodiments of the present disclosure;

FIG. 8 schematically illustrates a diagram of operation data during operation with breathing airflow in accordance with embodiments of the present disclosure;

FIGS. 9A-9B schematically illustrate diagrams of operation data for different types of masks in accordance with embodiments of the present disclosure; and

FIG. 10 schematically illustrates a schematic diagram of a computing device for implementing a method in accordance with embodiments of the present disclosure.

Throughout the drawings, the same or similar reference symbols are used to indicate the same or similar elements.

### DETAILED DESCRIPTION OF THE EMBODIMENTS

Principles of the present disclosure will now be described with reference to several example embodiments shown in the drawings. Though example embodiments of the present disclosure are illustrated in the drawings, it is to be understood that the embodiments are described only to facilitate those skilled in the art in better understanding and thereby achieving the present disclosure, rather than to limit the scope of the disclosure in any manner.

As discussed above, in order to adapt the performance of the fan to different types of the masks respectively, the fan may be configured to identify the mask type. Conventionally, there are some active mask products that have type reorganization function to identify the type and record the mask usage time. The most common solution is to add digital labels on the mask (such as radio-frequency identification (RFID) labels, or near-field communication (NFC) chips) and detecting function on fan module. However, the masks will be disposed after usage resulting in a huge waste when the digital labels are disposed together with the masks. At the same time, most of masks are very soft, and it is difficult to mount the label elements on the soft masks. Therefore, the digital label solution is high-cost and has technical problem.

In order to at least partially solve the above and other potential problems, a new mechanism is provided for determine the type of the mask according to embodiments of the present disclosure. According to the present disclosure, the operation characteristics of the fan are used as inputs to identify the mask type. In this way, additional identification components, such as extra labels can be spared. Mask type identification could be done during the normal mask usage automatically, thereby allowing the fan module to be adapted to the corresponding type at proper setting and provide higher-level comfortableness.

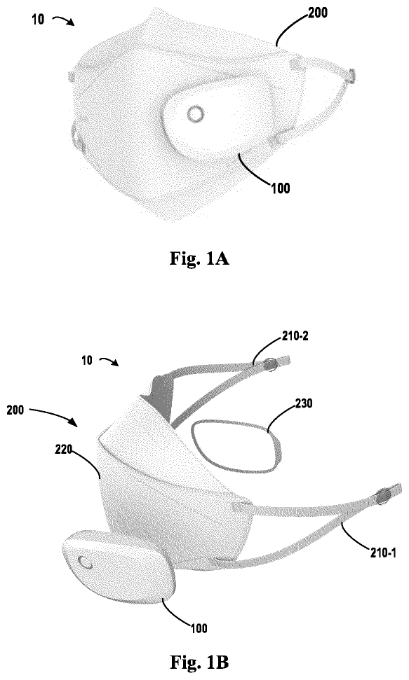

In the following, example constructions and operating principles of the harmonic reducer will be described with reference to FIGS. 1A-FIG. 10.

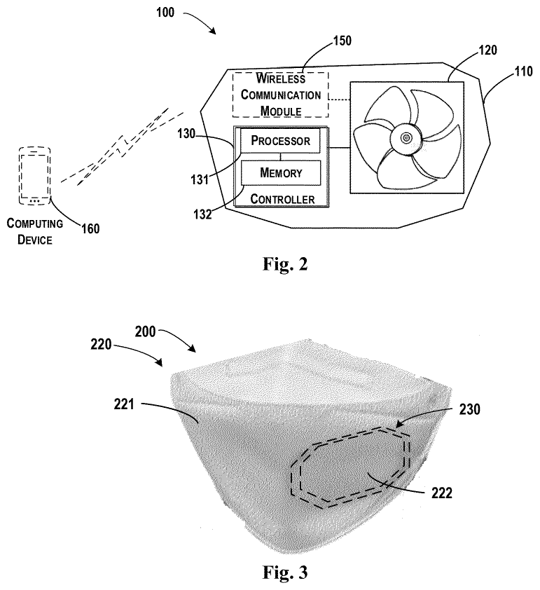

FIG. 1A schematically illustrates a face mask assembly 10 in an assembled state in accordance with embodiments of the present disclosure. As illustrated in FIG. 1A, the face mask assembly 10 includes a mask 200 for covering at least a portion of a face of a wearer to form a mask volume. In order to facilitate the airflow between the mask volume and the atmosphere in vicinity of the mask 200, a fan system 100 is secured on the surface of the mask 200. It should be appreciated that although the fan system 100 as illustrated in FIG. 1 is provided on the outer surface of the mask 200 opposite from the face of the wearer, the fan system 100 may also be provided on the inner side of the mask 200. The detailed structures of the fan system 100 and the mask 200 will be described with reference to FIGS. 2-3 later.

FIG. 1B schematically illustrates an exploded diagram of the face mask assembly 10 of FIG. 1A. As illustrated in FIG. 1B, the mask 200 includes an integrated filtration sheet 220 arranged between the mask volume and an atmosphere. The integrated filtration sheet 220 includes filter material and may filter the air flowing from the atmosphere into the mask volume and also the air flowing from the mask volume into the atmosphere. The filter material covers most part of the mask and the mask does not include any valve or other part that air can permeate. The mask further comprises connectors 210-1 and 210-2 for connecting the wearer. In this embodiment, the connectors 210-1 and 210-2 extend from the edge of the integrated filtration sheet 220 and can be hanged on the ears of the wearer. The mask may further comprise a bracket 230 on the inner side to support the fan system 100.

FIG. 2 schematically illustrates a fan system 100 in accordance with embodiments of the present disclosure. As illustrated in FIG. 2, the fan system 100 comprises a housing 110. In the housing 110, a fan 120 is provided. The fan 120 may include an electrical motor (for example, a brushless direct current (DC) motor) to drive blades of the fan 120 to rotate. The fan 120 operates to facilitate the airflow passing through the mask 200. The fan system 100 further comprises a controller 130 provided in the housing 110. The controller 130 may transmit drive signals to the electrical motor of the fan 120 to control the operation of the fan 120. The controller 130 may also collect operation data of the fan 120, such as speed, current and power consumption of the fan 120 from the electrical motor. The controller 130 further includes a processor 131 to process the collected operation data of the fan and a memory 132 storing instructions for the processor 131 to execute and other data essential for performing the pre-configured functions of the fan system 100. It should be appreciated that the controller 130 may be a processor.

The fan system 100 may further include a wireless communication module 150 coupled to the fan 130 and a computing device 160. The computing device 160 may communicate with the fan 120 via the wireless communication module 150 to receive operation data of the fan 120. Upon receiving operation data, the computing device 160 may process the operation data and generate instructions for the fan 120. The computing device 160 then transmits the generated instructions to the fan 120 via the wireless communication module 150 remotely.

FIG. 3 schematically illustrates a mask 200 of FIG. 1A. As illustrated in FIG. 3, the integrated filtration sheet 220 of the mask 200 comprises a first portion 221 and a second portion 222. The second portion 222 is defined by the bracket 230. When the fan system 100 is secured by means of the bracket 230, the fan system 100 and the bracket 230 enclose the second portion 222 and form a filtration channel passing through the second portion 222. When the wearer inhales, the air flows from the atmosphere into the mask volume through the first portion 221 and when the wearer exhales, the air flows from the mask volume into the atmosphere through the second portion 222. Thus, the first portion 221 may also be referred to as “an inlet filtration portion” and the second portion 222 may also be referred to as “an outlet filtration portion”. It should be appreciated that although the fan system 100 is provided on the outer side of the mask 200 and facilitate the air flows out of the mask volume, the fan system 100 may also be provided on the inner side of the mask 200 and configured to facilitate the air flows into the mask volume. In these cases, the second portion which is in the airflow channel formed by the fan system may also be an inlet filtration portion and the first portion outside the second portion may be an outlet filtration portion.

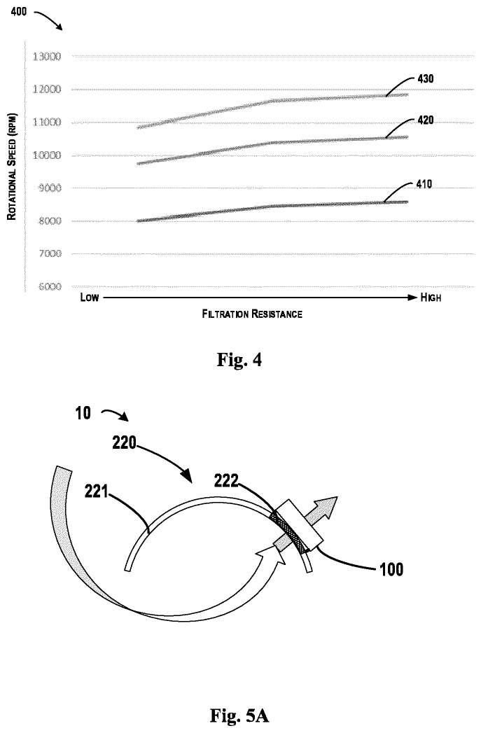

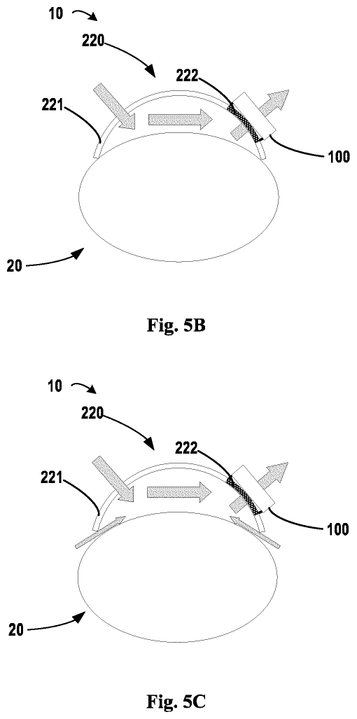

The second portion 222 has a predetermined filtration characteristic which is associated with its type. For example, a KN95/N95 mask has a higher filtration resistance than the normal medical mask. Moreover the filtration characteristics would be indicated by more than a filtration resistance value for the mask, such as, filtration resistance-pressure difference curve, filtration resistance-flow rate curve, filtration resistance-rotation rate curve tendency, characteristic of the curve, or filtration resistance values of more than one testing points to determine the type of the mask similarly to value comparison illustrated in the embodiment here. Therefore, the filtration characteristic of a mask may indicate the type of the mask. In addition, it has been surprisingly found that the filtration characteristic of the mask is also associated with the operation performance of the fan. In the following, the relationship between the operation performance of the fan and the filtration characteristic of the mask will be described with reference to FIGS. 4 to 5C.

FIG. 4 schematically illustrates a diagram 400 of speeds of the fan over different filtration resistance in accordance with embodiments of the present disclosure. As illustrated in FIG. 4, the fan 120 can operate at 3 power levels. The rotational speed curve 410 at power level 1 increases approximately from 8000 revolutions per minute (rpm) to 8600 rpm. The rotational speed curve 420 at power level 2 increases from approximately 9900 rpm to 10600 rpm. The rotational speed curve 430 at power level 3 increases approximately from 10950 rpm to 11950 rpm. The lowest speed may correspond to the case without attaching to a mask. The middle speed may correspond to the case with a normal medical mask. The highest speed may correspond to the case with a KN95/N95 mask. It can be seen that under a certain power level, the rotational speed of the fan 120 increases as the filtration resistance of the mask 200 increases and the rotational speed associated with a type of the mask lies in a certain range. Therefore, the type of the mask may be distinguished by different threshold ranges of the rotational speed.

In the following, derivation of the relationship between the rotational speed of the fan 120 and the filtration resistance are described. It is known that the rotational speed of the fan 120 is reverse proportional to the loading (namely the airflow) by a coefficient:

$${S}_{fan} = \frac{{k}_{1}}{{Q}_{fan}} \qquad ( 1 )$$

where S_{fan} is the rotational speed of the fan 120, Q_{fan} is the load applied to the fan 120 and k₁ is a predetermined coefficient related to the design of the fan 120.

In the face mask assembly, the airflow going through the fan 120 is determined by both operation characteristics of the fan 120 and filtration resistance of the mask. The operation characteristics of the fan 120 follows:

P_{fan}=P_{fan_max}−k₂·Q_{fan} (2)

where P_{fan} is the pressure of the fan 120 during operation, P_{fan_max} is the maximal static pressure of the fan 120 which is determined by fan design, k₂ is another predetermined coefficient also related to fan design. In addition, k₂ and P_{fan_max} can be obtained by measurement.

Considering the filtration resistance of the mask 200 which follows:

Pₘₐₛₖ=Qₘₐₛₖ·Rₘₐₛₖ (3)

where Rₘₐₛₖ denotes the filtration resistance of the mask 200, with pressure and airflow balance:

P_{fan}=Pₘₐₛₖ (4)

Q_{fan}=Qₘₐₛₖ (5)

it can be calculated:

$${Q}_{fan} = \frac{{P}_{fan \_ max}}{{R}_{mask} + {k}_{2}} . \qquad ( 6 )$$

Based on equations (1) and (2), it can be derived:

$${S}_{fan} = \frac{{k}_{1}}{{Q}_{fan}} = \frac{{k}_{1} \cdot ( {R}_{mask} + {k}_{2} )}{{P}_{fan \_ max}} = {C}_{1} \cdot {R}_{mask} + {C}_{2} \qquad ( 7 )$$

$${C}_{1} = \frac{{k}_{1}}{{P}_{fan \_ max}} \qquad ( 8 )$$

$${C}_{2} = \frac{{k}_{1} {k}_{2}}{{P}_{fan \_ max}} . \qquad ( 9 )$$

Since both C₁ and C₂ are only related to fan design, once the fan is determined, C₁ and C₂ are fixed. Therefore, the rotational speed of the fan 120 under certain driving voltage is directly proportional to the filtration resistance of the mask 200. Further, the filtration resistance of the mask is also related to how the mask is worn and the relationship therebetween will be described in details with reference to FIGS. 5A-5C.

FIG. 5A schematically illustrates a schematic diagram of an airflow model of the face mask assembly 10 without being worn. As illustrated in FIG. 5A, the second portion 222 of the integrated filtration sheet 220 is aligned with the fan system 100. The face mask assembly 10 is not worn and the air flows directly to the second portion 222 and then is facilitated by the fan 120 and flows through the second portion 222 and the fan system 100 into the atmosphere. In this scenario, the filtration resistance of the mask 200 is the same as the filtration resistance of the second portion 222:

Rₘₐₛₖ=R_{second portion} (10)

where R_{second portion} denotes the filtration resistance of the second portion 222. Therefore, the rotational speed of the fan 120 depends on the filtration resistance of the second portion 222.

FIG. 5B schematically illustrates a schematic diagram of an airflow model of the face mask assembly 10 being worn without leakage. As illustrated in FIG. 5B, the face mask assembly 10 is properly worn by a wearer 20. The air flows from the atmosphere into the mask volume through the first portion 221. Under the effect of the rotation of the fan 120 of the fan system 100, the air in the mask volume flows to the second portion 222 and flows through the second portion 222 and the fan system 100 into the atmosphere. The filtration resistance of the mask 200 can be considered as a summation of a series connection of the filtration resistance of the first portion 221 and the filtration resistance of the second portion 222:

Rₘₐₛₖ=R_{first portion}+R_{second portion} (11)

where R_{first portion} denotes the filtration resistance of the first portion 221. Since the first portion 221 and the second portion 222 are typically made of the same material, the ratio of their filtration resistance is the inverse of the ratio of their size. In some embodiments, the size of the second portion 222 may be about ⅙ of the size of the first portion 221. Thus, the filtration resistance of the second portion 222 is about 6 times as that of the first portion 221:

$${R}_{first portion} = \frac{{R}_{s econd portion}}{6} \qquad ( 12 )$$

$${R}_{mask} = \frac{7}{6} {R}_{s econd portion} . \qquad ( 13 )$$

Therefore, the rotational speed of the fan 120 mainly depends on the filtration resistance of the second portion 222, which is the portion connected to the fan system 100.

FIG. 5C schematically illustrates a schematic diagram of an airflow model of the face mask assembly 10 being worn with leakage. As illustrated in FIG. 5C, the face mask assembly 10 is not properly worn by the wearer 20 which results in a gap between the mask 200 and the face of the wearer 20. In this scenario, the air flows from the atmosphere into the mask volume through the first portion 221 and the gap between the mask 200 and the wearer 20. Under the effect of the rotation of the fan 120 of the fan system 100, the air in the mask volume flows to the second portion 222 and flows through the second portion 222 and the fan system 100 into the atmosphere. The increase of the airflow amount from the leakage could be considered as the decrease of the filtration resistance of the first portion 221. Compared to the embodiments as illustrated in FIG. 5B, the ratio of the filtration resistance of the first portion 221 with respect to the filtration resistance summation of the first portion 221 and the second portion 222 becomes even smaller. Therefore, the rotational speed of the fan 120 also mainly depends on the filtration resistance of the second portion 222.

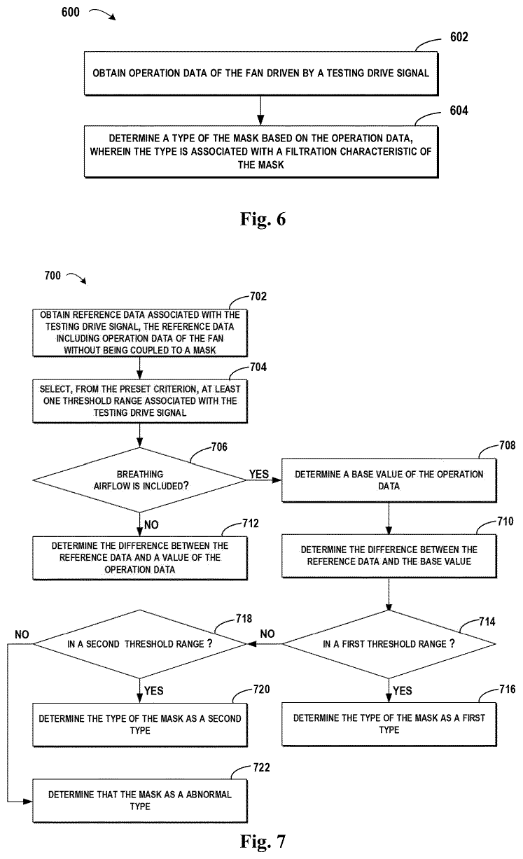

To conclude, in all the wearing scenarios as illustrated in FIGS. 5A-5C, the rotational speed of the fan 120 is related to the filtration resistance of the mask 200 which mostly depends on the filtration resistance of the second portion 222 in the air path formed by the fan 120. Hence, by monitoring the rotational speed of the fan 120, the filtration resistance of the second portion 222 can be determined for identity the type of the mask. The method for determining the type of the mask based on the operation performance of the fan will be described with reference to FIGS. 6-7.

FIG. 6 schematically illustrates a flowchart of a method 600 for determining a type of a mask in accordance with embodiments of the present disclosure. The method 600 may be implemented by the controller 130 or the computing device 160 in FIG. 2. For the sake of brevity without loss of generality, the method hereinafter will be described with reference to FIGS. 2-3.

At 602, the controller 130 obtains operation data of the fan 120 driven by a testing drive signal. When the fan system 100 of the face mask assembly 10 is turned on, a type identification procedure may be automatically initiated. In the type identification procedure, the controller 130 transmits a testing drive signal to control the fan 120 to rotate under a testing condition, for example under a certain drive voltage. The controller 130 collects the operation data of the fan 120 for example from its motor. The testing condition may be a specifically configured condition or a normal operation condition of the fan 120.

At 604, the controller 130 determines a type of the mask based on the operation data. In this case, the type is associated with a filtration characteristic of the mask as discussed above. After the operation data of the fan 120 is collected, the controller 130 may process the data and determines the type of the mask 200. In this way, the type of the mask can be determined merely based on the collected operation data without additional indication mechanism.

FIG. 7 schematically illustrates a flowchart of a method 700 for determining a type of a mask based on the collected data in accordance with further embodiments of the present disclosure. The method 700 may correspond to the step 604 of the method 600. The method 700 may also be implemented by the controller 130 or the computing device 160 in FIG. 2.

At 702, the controller 130 obtains reference data associated with the testing drive signal. The rotational speeds of the fans of the same model may be slightly different from each other due to manufacture tolerance. In this case, the reference data includes operation data of the fan without being coupled to a mask. This basic operation data of the fan 120 may be detected as the reference data before sale. In some embodiments, the reference data may be stored in the memory 132.

At 704, the controller 130 selects at least one threshold range associated with the testing drive signal from the preset criterion. The preset criterion may include a plurality of sets of threshold ranges. Each set of the threshold ranges may be associated with one of a plurality of the power levels. The number of the threshold ranges in each set may correspond to the number of the type of the mask. For example, if the fan 120 has 3 power levels and is adapted to two types of the masks, such as normal medical mask and KN95/N95 mask, the preset criterion may include 3 sets of threshold ranges and each set includes two threshold ranges corresponding to the two types. The threshold ranges may be obtained by tests and stored in the memory 132.

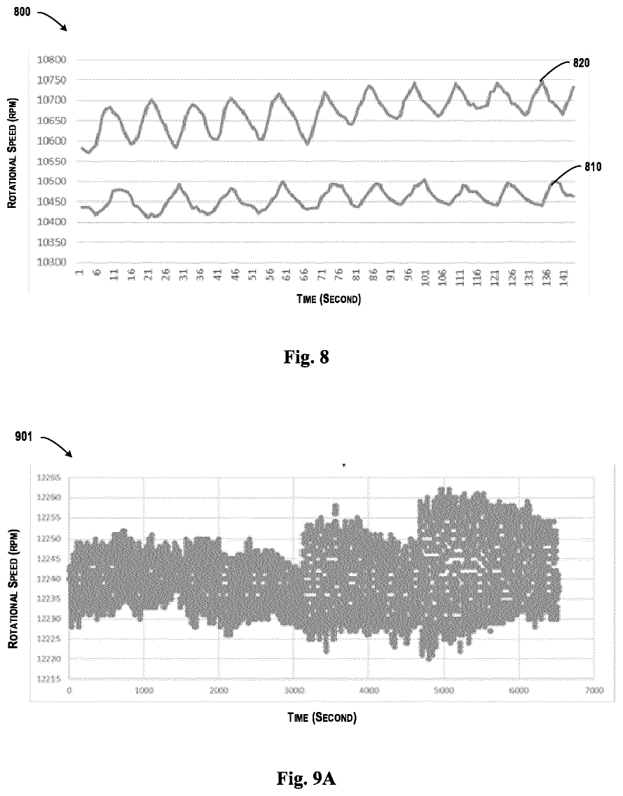

At 706, the controller 130 determines whether an overall airflow passing through the fan system includes breathing airflow based on the operation data. If the wearer turns on the fan while wearing the mask, the overall airflow passing through the fan system 100 may include breathing airflow exhaled by the wearer. Since breathing airflow is oscillatory, the operation data will also be oscillatory which is illustrated in FIG. 8.

FIG. 8 schematically illustrates a diagram 800 of operation data during operation with breathing airflow in accordance with embodiments of the present disclosure. As illustrated in FIG. 8, the rotational speed of the fan 120 oscillates over time. In particular, the rotational speed curve 810 of the fan 120 coupled to a mask with lower filtration resistance oscillates approximately between 10400 rpm and 10500 rpm. The rotational speed curve 820 of the fan 120 coupled to a mask with higher filtration resistance oscillates approximately between 10550 rpm and 10750 rpm.

Back to FIG. 7, if the controller 130 determines that the overall airflow passing through the fan system includes breathing airflow based on the operation data. For example, if the operation data has an oscillatory pattern, the breathing airflow is included. The method 700 proceeds to 708. At 708, the controller 130 the controller determines a base value of the operation data and determines the difference between the reference data and the base value at 710. In this case, specific data needs be selected as a base value for subsequent calculations. In some example embodiments, the base value may be the maximum value, minimum value or mean value of the operation data.

If the controller 130 determines that the overall airflow passing through the fan system does not include breathing airflow based on the operation data. For example, if the operation data has a linear pattern, the breathing airflow is not included. The method 700 proceeds to 712. At 712, the controller 130 determines the difference between the reference data and a value of the operation data. In this case, the operation data of the fan 120 may be substantially same which means the difference of the operation data is in an acceptably small range. Therefore, any one of the operation data can be used for subsequent calculation. In some example embodiments, a statistical value of the operation data may be determined for calculating the difference.

After the difference is determined, the controller 130 compares the difference with the selected threshold ranges in sequence. At 714, the controller 130 determines whether the difference is in a first threshold range of the at least one threshold range. If the controller 130 determines that the difference is in a first threshold range. The method proceeds to 716 and the controller 130 determines the type of the mask as a first type at 716.

If the controller 130 determines that the difference is not in the first threshold range. The method proceeds to 718 and the controller 130 determines whether the difference is in a second threshold range of the at least one threshold range. The second ranges may be adjacent to the first threshold range and the threshold values in the second threshold range are lower than threshold values in the first threshold range. If the controller 130 determines that the difference is in the second threshold range. The method proceeds to 720 and the controller 130 determines the type of the mask as a second type at 720.

Further, if the controller 130 determines that the difference is not in the second threshold range which means the difference is neither in the first threshold range nor in the second threshold range. The method proceeds to 722 and the controller 130 determines the type of the mask as an abnormal type at 722. If the type of the mask does not correspond to any of the preconfigured types, the fan system 100 may not be adapted to this type of mask and may not provide a comfortable breathing experience.

In this way, by comparing a difference between the collected data and the corresponding reference data with threshold ranges, the type of the mask can be accurately determined. In some example embodiments, once the type of the mask is determined, the controller 130 may select a customized driving solution corresponding to the type. Then, the controller 130 may generate a customized drive signal and control the fan to operate with the customized drive signal.

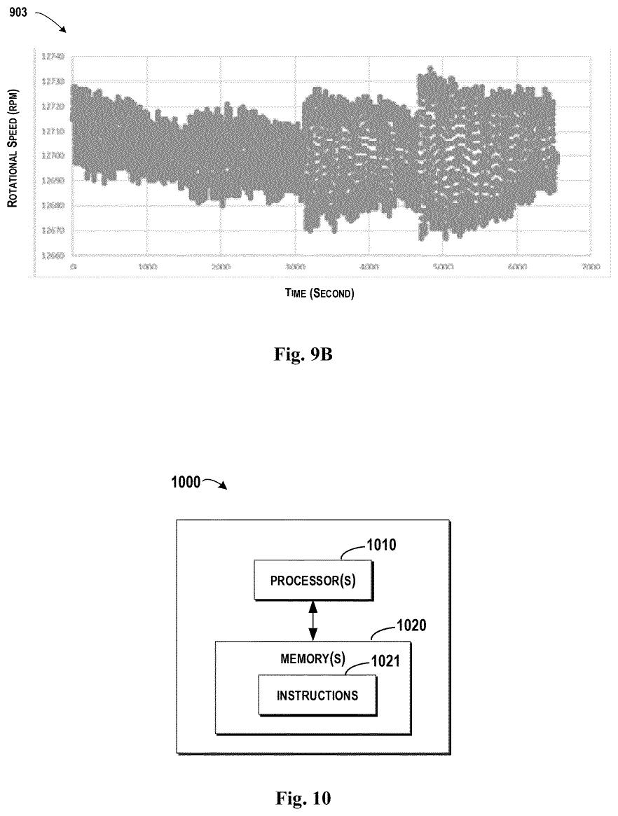

In the following, specific example procedures for determining a type of a mask are illustrated with reference to FIGS. 9A-9B. The FIG. 9A schematically illustrates a diagram 901 of rotational speed of the fan 120 at power level 3 for a normal medical mask. Once the operation data is obtained, the controller 130 processes the data and determines that the data in the diagram 901 has an oscillatory pattern and therefore breathing airflow is involved. According to diagram 901, the detected maximum value of the rotational speed is 12262 rpm and the minimum value of the rotational speed is 12220 rpm. Therefore, a mean value of 12241 rpm between the maximum value and minimum value can be determined as a base value. In the memory 132, a reference value associated with the fan 120 at power level 3 is stored, namely a rotational speed of 12250 rpm. Then, the difference between the base value and the reference value is calculated by:

S_{difference}=|S_{base}−S_{reference}|=|12241−12250|=9 (14)

where S_{difference} denotes the rotational speed difference, S_{base} denotes the base value and S_{reference} denotes the reference value.

In this case, for a fan operating under power level 3, the threshold range for normal medical masks may be [0, 50] and the threshold range for KN95/N95 masks may be (50, +∞). Therefore, the calculated difference is in the threshold range for normal medical masks and it is concluded that the mask is a normal medical mask.

The FIG. 9B schematically illustrates a diagram 903 of rotational speed of the fan 120 at power level 3 for a KN95/N95 mask. Similarly, the data in the diagram 903 also has an oscillatory pattern and therefore it can be determined that breathing airflow is involved. According to diagram 903, the detected maximum value of the rotational speed is 12735 rpm and the minimum value of the rotational speed is 12667 rpm. Therefore, a mean value of 12701 rpm between the maximum value and minimum value can be determined as a base value. The reference value is also 12250 rpm. Then, the difference between the base value and the reference value is calculated by:

S_{difference}=|S_{base}−S_{reference}|=|12701−12250|=451. (15)

In this case, according to the same threshold ranges as discussed above, the calculated difference is in the threshold range for KN95/N95 masks and it is concluded that the mask is a KN95/N95 mask.

FIG. 10 illustrates a schematic diagram of a computing device 1000 for implementing a method in accordance with embodiments of the present disclosure. The computing device 1000 may comprise the controller 130 and/or the computing device 160. The computing device 1000 comprises: at least one processor 1010 and at least one memory 1020. The at least one processor 1010 may be coupled to the at least one memory 1020. The at least one memory 1020 comprises instructions 1022 that when executed by the at least one processor 1010 implements the method 600 or 700.

In some embodiments of the present disclosure, a computer readable medium for adjusting robot path is provided. The computer readable medium has instructions stored thereon, and the instructions, when executed on at least one processor, may cause at least one processor to perform the method for managing a camera system as described in the preceding paragraphs, and details will be omitted hereinafter.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 6 and 7. Generally, program modules include routines, programs, libraries, objects, classes, components, data structures, or the like that perform particular tasks or implement particular abstract data types. The functionality of the program modules may be combined or split between program modules as ideal in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. On the other hand, various features that are described in the context of a single embodiment may also be implemented in multiple embodiments separately or in any suitable sub-combination.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It should be appreciated that the above detailed embodiments of the present disclosure are only to exemplify or explain principles of the present disclosure and not to limit the present disclosure. Therefore, any modifications, equivalent alternatives and improvement, etc. without departing from the spirit and scope of the present disclosure shall be included in the scope of protection of the present disclosure. Meanwhile, appended claims of the present disclosure aim to cover all the variations and modifications falling under the scope and boundary of the claims or equivalents of the scope and boundary.

1. A fan system adapted to be coupled to a mask, comprising:
a fan configured to facilitate an airflow passing through a filter material of the mask; and
a controller configured to control the fan to operate with a drive signal,
wherein the controller is further configured to:
obtain operation data of the fan driven by a testing drive signal; and
determine a type of the mask based on the operation data, wherein the type is associated with a filtration characteristic of the mask.

2. The fan system according to claim 1, wherein,
the controller is configured to determine the type of the mask solely based on the operation data of the fan.

3. The fan system of claim 1, wherein the controller is further configured to determine the type of the mask by:
obtaining reference data associated with the testing drive signal, the reference data including operation data of the fan without being coupled to a mask; and
determining the type based on the reference data, the operation data, and a preset criterion.

4. The fan system of claim 3, further comprising:
a memory, configured to store the reference data and the preset criterion as fan specification.

5. The fan system of claim 3, wherein the controller is further configured to determine the type of the mask by:
selecting, from the preset criterion, at least one threshold range associated with the testing drive signal;
determining a difference between the reference data and the operation data; and
in response to determining that the difference is in a first threshold range of the at least one threshold range, determining the type of the mask as a first type, and/or
in response to determining that the difference is in a second threshold range of the at least one threshold range, determining the type of the mask as a second type, wherein the second type has a lower filtration resistance than the first type, and threshold values in the second threshold range are lower than threshold values in the first threshold range.

6. The fan system of claim 5, wherein determining the difference between the reference data and the operation data comprises:
determining whether an overall airflow passing through the fan system includes breathing airflow based on the operation data;
in response to determining that the overall airflow includes the breathing airflow, determining a base value of the operation data and determining the difference between the reference data and the base value, and/or
in response to determining that the overall airflow does not include the breathing airflow, determining the difference between the reference data and a value of the operation data.

7. The fan system of claim 1, wherein the controller is further configured to determine the type of the mask by:
obtaining reference data associated with the testing drive signal, the reference data including operation data of the fan without being coupled to a mask; and
in response to determining that the reference data and the operation data do not satisfy a preset criterion, determining the type of the mask as an abnormal type.

8. The fan system of claim 1, wherein the controller is further configured to:
generate a customized drive signal for the determined type; and
control the fan to operate with the customized drive signal.

9. The fan system of claim 1, wherein the operation data comprises at least one of:
a speed value and/or sequence of the fan;
a current value and/or sequence of the fan; or
power consumption value and/or sequence of the fan.

10. A mask for covering at least a portion of a face of a wearer to form a mask volume, comprises:
a connector for connecting to the wearer; and
an integrated filtration sheet arranged between the mask volume and an atmosphere, at least one piece of the integrated filtration sheet is directly and/or indirectly secured to the connector and the integrated filtration sheet having an inlet filtration portion and an outlet filtration portion,
wherein the inlet filtration portion and/or the outlet filtration portion has a predetermined filtration characteristic to indicate a type of the mask,
one of the inlet filtration portion or the outlet filtration portion is adapted for coupling,
the filtration resistance of the one of the inlet filtration portion or the outlet filtration portion is larger than another one of the inlet filtration portion or the outlet filtration portion.

11. The mask of claim 10, further comprises,
a visual indicator to indicate the one of the inlet filtration portion or the outlet filtration portion for coupling.

12. The mask of claim 10, wherein the inlet filtration portion is configured to be passed through by airflow from the atmosphere to the mask volume when the wearer inhales, and
the outlet filtration portion is configured to be passed through by airflow from the mask volume to the fan system when the wearer exhales.

13. The mask of claim 10, wherein:
the filtration resistance of the one of the inlet filtration portion or the outlet filtration portion is 6 times of another one of the inlet filtration portion or the outlet filtration portion.

14. A face mask assembly, comprising:
a mask for covering at least a portion of a face of a wearer; and
a fan system as claimed in claim 1 coupled to the mask and configured to facilitate an airflow passing through the filter material of the mask.

15. A method for determining a type of a mask, comprising:
obtaining operation data of a fan coupled to a mask driven by a testing drive signal, the fan is configured to facilitate an airflow passing through a filter material of the mask; and
determining a type of the mask based on the operation data, the type is associated with a filtration characteristic of the mask.

16. A computer program product comprising a computer readable medium, the computer readable medium having computer readable code embodied therein, the computer readable code is configured such that, on execution by a controller of a fan system, the controller is caused to perform the method as claimed in claim 15
